(19) United States
(12) Patent Application Publication
(10) Pub. No.: US 2003/0222361 A1
(43) Pub. Date: Dec. 4, 2003

(54) Method of producing a plastic optical component

(75) Inventors: Fumiyuki Suzuki, Kanagawa (JP); Tadashi Mochizuki, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/452,728

(22) Filed: Jun. 3, 2003

(30) Foreign Application Priority Data
Jun. 3, 2002 (JP) 2002-161392

(51) Int. Cl. B29D 11/00

(52) U.S. Cl. 264/1.1; 264/85

(57) ABSTRACT

There is provided a method of producing a plastic optical component from a plastic material using an injection molding machine. This method removes foreign matter from a molten plastic material having dissolved therein 0.1 mass % or more of carbon dioxide through a filter arranged midway through a passage for the molten plastic material provided in the injection molding machine and injects the molten plastic material into a molding die preliminarily pressurized with a pressurization gas to prevent foaming of the molten plastic material. Even when a high filtration precision filter is provided in the injection molding machine, the filtration pressure loss is low and there is no breakage of a filter. It is also possible to significantly reduce the fraction defective of plastic optical components due to contamination by foreign matter or clouding resulting from foaming of carbon dioxide.

### BACKGROUND OF THE INVENTION

1. Field of the Invention

The present invention relates to a method of producing a plastic optical component, and more particularly to a method of producing a plastic optical component capable of providing a plastic optical component that contains a small content of foreign matter or that has a small probability of containing those foreign matter whose size would impair the optical performance of the optical component even though the optical component contains a certain amount of foreign matter.

2. Description of the Related Art

Heretofore, the optical components such as: various lenses or finders of cameras; various lenses or prisms used in copying machines, printers, projectors, optical communication and so forth; as well as eyeglass lenses; contact lenses; and magnifying glasses have been mostly produced from glass as a material. However, associated with the progress in the injection molding technology in recent years, lenses and prisms made of plastic, raw materials of which are inexpensive and which can be mass-produced and are light in weight have come to be used.

In the case of the optical components made of glass, the foreign matter is decomposed and burned during the melting step of glass of a raw material if the foreign matter is an organic substance. On the other hand, if the foreign matter is an inorganic substance, the foreign matter is molten and uniformly mixed with the substantial body of the glass material. In any case, most of the foreign matter will be lost. However, in the case of the plastic optical component, that is to say, the optical components made of plastic, the molding temperature is at most around 300° C., so that the foreign matter that was generated during the production process of the optical components or got in the plastic material would remain almost as it is in the optical component as a product.

If the foreign matter remains in such optical components, in particular, if the foreign matter remains in optical paths, the foreign matter would shade or scatter light incident on the optical components, so that the optical components fail to properly refract the incident light and cause various problems such as deflection of the light path of transmitted light, decrease in the amount of transmitted light, distortion of a focused image, and deterioration in contrast, which may cause the function of the optical component to be impaired. Therefore, in the case of optical components such as photographic lenses and finders for cameras (inclusive of cameras for the silver photographic system, digital cameras, and video cameras), contamination by foreign matter may impair the function itself of the optical component. Furthermore, even if the foreign matter is present to such an extent that no impairment of the function itself of the optical component is caused thereby, the presence of visually recognizable foreign matter in the optical component causes users to have a distrust of the high-precision instruments and thus is not preferable. For this reason, in the production of plastic optical components by an injection molding method, the fraction defective of products due to contamination by foreign matter is high, sometimes reaching as high as 24% in extreme cases, which causes an increase in production loss, a decrease in yield, and an increase in production cost.

On the other hand, in the case where plastic products such as containers are molded, a molding machine is provided with means such as a filter or a strainer for removing foreign matter mixed into plastic materials, in order to prevent the problems of short circuit failure due to the plugging of the gate, stoppage of the installation due to the loss associated with the plugging of the gate, appearance failure after passing the gate, and the like. In particular, recycled resins that have been used with increasing frequencies in recent years contain a large amount of foreign matter and hence it is indispensable to provide means for removing foreign matter in the molding machine. Accordingly, a method in which a strainer or the like is attached to an injection molding machine has been proposed (cf. JP 53-21260 A, JP 3-140225 A, JP 6-206240 A, and JP 10-21728 A). For example, JP 6-206240 A discloses a filter nozzle device of an injection molding machine. In the filter nozzle device is arranged a cylindrical filter passing a resin material from an inner peripheral side to an outer peripheral side and removing the foreign matter in a resin passage formed in a nozzle provided on a front end of an injection cylinder, and also a bypass passage for the filter is formed in the nozzle introducing the resin material supplied to the inner peripheral side of the filter in the resin passage to a tip hole of the nozzle without allowing the resin material to pass the filter, and besides a valve mechanism is provided which closes the bypass passage at the time of injection molding and otherwise opens the bypass passage.

However, the foreign matter that is the target for removal in such conventional injection molding machines is large foreign matter as large as about 50 μm in outer diameter. On the contrary, in those products that require high precision, such as optical components, the presence of foreign matter having a smaller outer diameter, for example, as small as about 20 μm in outer diameter causes a problem. Notwithstanding, there has conventionally been no idea of removing foreign matter mixed into optical components during injection molding. This is ascribable to a relatively high melt viscosity of the resin material used in plastic optical components and absence of filter materials corresponding to the high melt viscosity that can exhibit high filtration precision and high resistance to pressure loss when the injection molding speed is elevated in order to increase the production efficiency of the production line, resulting in breakage of the filter. Also, the absence of the idea is ascribable to the fact that it is substantially impossible to decrease the pressure loss by increasing the filtration area under the constraint that the site in the injection molding machine where the filter is arranged is limited. For this reason, conventionally, there has been a problem in that an expensive resin material of high purity containing no foreign matter therein must be used as a starting resin material for use in injection molding of optical components.

### SUMMARY OF THE INVENTION

Accordingly, an object of the present invention is to solve the prior art problems described above by providing a method of producing a plastic optical component which can decrease the viscosity of a molten plastic material, has a low filtration pressure loss and causes no breakage of a filter even when a filter of high filtration precision is provided in an injection molding machine, and is capable of obtaining a plastic optical component with a low probability of containing foreign matter as well as decreases failure due to the contamination by foreign matter and is effective in increasing the yield and reducing the cost.

To solve the above-mentioned problems, the inventors of the present invention have made extensive studies and as a result the inventors have found that dissolving carbon dioxide in a molten plastic material to decrease the melt viscosity thereof results in a decrease in pressure loss in the filter, thereby decreasing the pressure resistance property required for the filter and the filter requires only a small filtration area, so that foreign matter having a size that would cause a problem in the optical performance of optical components can be removed by use of a filter.

On the other hand, in the case where the molten plastic material having carbon dioxide dissolved therein is injected as it is into a molding die, low pressures in the die cause gasification, foaming of carbon dioxide dissolved in the molten plastic material, clouding and in extreme cases giving a porous molding having so-called “porosity” therein, so that such a molded product cannot be used as an optical component. Accordingly, the inventors of the present invention has further made studies and as a result the inventors have found that injection molding performed after preliminarily pressurizing the inside of a molding die with a pressurizing gas prevents gasification/evaporation of carbon dioxide dissolved in the molten plastic material and is effective to obtain optical components that are free of defects such as clouding.

According to the present invention, there is provided a method of producing a plastic optical component from a plastic material using an injection molding machine, comprising: removing foreign matter from a molten plastic material having dissolved therein 0.1 mass % or more of carbon dioxide through a filter arranged midway through a passage for the molten plastic material provided in the injection molding machine; and injecting the molten plastic material into a molding die of the injection molding machine, the molding die being preliminarily pressurized with a pressurization gas to prevent foaming of the molten plastic material.

Preferably, the carbon dioxide is dissolved in the molten plastic material in a dissolution amount of 0.5 to 5 mass %.

Preferably, the carbon dioxide is dissolved in the molten plastic material by a method comprising supplying the carbon dioxide together with the plastic material through a starting material charging hopper provided for supplying the plastic material into the injection molding machine.

Preferably, the carbon dioxide is dissolved in the molten plastic material by a method comprising supplying the carbon dioxide through a nozzle provided in a screw cylinder of the injection molding machine separately from the plastic material.

Preferably, the nozzle for supplying the carbon dioxide provided in the screw cylinder is arranged midway through a passage for the molten plastic material from a starting material charging hopper of the injection molding machine to an injection nozzle of the injection molding machine.

Preferably, the nozzle for supplying the carbon dioxide is arranged midway through the passage from a plasticizing region of the plastic material in the screw cylinder to the injection nozzle.

Preferably, the filter is arranged in a bore of an injection nozzle located at a tip of the injection molding machine.

Preferably, the filter has a filtration precision of 50 μm or less.

Preferably, the filter has a filtration precision of 20 μm or less.

Preferably, the filter is of a material that has sufficient heat resistance, pressure resistance or mechanical strength at a temperature of the molten plastic material.

Preferably, the material of the filter is stainless steel.

Preferably, the filter comprises a member selected from the group consisting of nonwoven fabrics of stainless steel fiber, stainless steel meshes, sintered products of the nonwoven fabrics of the stainless steel fiber and the stainless steel meshes, and sintered stainless steel powder.

Preferably, pressurization in the molding die with the pressurization gas is retained to prevent foaming after the molten plastic material is injected, and wherein the pressurization is released after the molten plastic material in the molding die is cooled and solidified, and a plastic optical component is taken out of the molding die.

Preferably, the pressurization gas for pressurizing an inside of the molding die is one member selected from the group consisting of carbon dioxide, nitrogen, methane, ethane, flon (chloro-fluorocarbon), and mixtures thereof.

Preferably, the pressurization gas is carbon dioxide.

Preferably, the plastic material is a member selected from the group consisting of methacrylic resins, acrylic resins, polycarbonate resins, polystyrene resins, acrylonitrile/styrene resins, tricyclodecane-ring-containing resins, cycloolefin polymers, polymethylpentenes, styrene/butadiene copolymers, and fluorene-group-containing polyesters.

### BRIEF DESCRIPTION OF THE DRAWINGS

FIG. 1 is a sectional view schematically showing an embodiment of an injection molding machine which is used to implement a method of producing a plastic optical component according to the present invention;

FIG. 2 is a partially enlarged sectional view showing an essential part including an injection nozzle of the injection molding machine shown in FIG. 1;

FIG. 3 is an enlarged sectional view of a filter provided in the injection nozzle shown in FIG. 2;

FIG. 4A is a plan view of an exemplary aspherical lens produced by the method of producing a plastic optical component according to the present invention; and

FIG. 4B is a sectional view of the aspherical lens shown in FIG. 4A.

### DETAILED DESCRIPTION OF THE PREFERRED EMBODIMENTS

Hereinafter, the method of producing a plastic optical component according to the present invention (hereinafter referred to simply as “the inventive method”) will de described in more detail.

In the inventive method, the term “optical component” refers to a member or component that is used as incorporated in various instruments such as: photographic lenses or finders of cameras (inclusive of cameras for the silver photographic system, digital cameras, and video cameras); various lenses or prisms used in copying machines, printers, projectors, optical communication and so forth; as well as eyeglasses lenses; contact lenses; and magnifying glasses or used singly and that exhibits optical functions.

In the inventive method, the plastic material used as a raw material of plastic optical components is not particularly limited and any raw material that can be commonly used as a raw material for plastic optical components may be used. Examples of such a plastic material include methacrylic resins (for example, PMMA), acrylic resins, polycarbonate resins, polystyrene resins, acrylonitrile/styrene (AS) resins, tricyclodecane-ring-containing resins, cycloolefin polymers, polymethylpentenes, styrene/butadiene copolymers, and fluorene-group-containing polyesters.

Further, the injection molding machine that can be used in the inventive method is not particularly limited so far as the machine can mix carbon dioxide with a molten plastic material under pressure before the molten plastic material is injected into a molding die. For molding optical components, models of an injection molding machine that are capable of high-precision injection control are preferable.

In the inventive method, the plastic material supplied to an injection molding machine is molten by heating and plasticized in the cylinder of the injection molding machine. On this occasion, the heating temperature at which the plastic material is plasticized and molten, the number of rotation of the screw for kneading the plastic material in the cylinder and the like factors may be selected as appropriate depending on the kind and amount of the plastic material to be used, the melt viscosity to be required, and so forth.

Also, in the inventive method, after the plastic material has been melt and kneaded in the cylinder of the injection molding machine to prepare a molten plastic material, carbon dioxide is dissolved in the molten plastic material. This decreases the viscosity of the molten plastic material, thereby decreasing the pressure loss at the time of filtration by the filter described hereinbelow and enabling sufficient removal of foreign matter having the predetermined size, even with a filter having a small filtration area. For example, when carbon dioxide is dissolved in the molten plastic material, the melt viscosity of the molten plastic material is decreased by 30 to 50% depending on the conditions, thereby enabling decreasing the pressure loss at the time of filtration with the filter described hereinbelow. It is also possible to decrease the filtration area as needed to decrease an unnecessary retained portion.

The dissolution amount of carbon dioxide to be dissolved in the molten plastic material is 0.1 mass % or more, preferably 0.5 to 5 mass %. If the dissolution amount is less than 0.1 mass %, the effect of decreasing the viscosity of the molten plastic material is little.

The method of dissolving carbon dioxide in the molten plastic material may be performed by any method so far as the method used is capable of dissolving carbon dioxide in the molten plastic material in the screw cylinder of an injection molding machine. Examples thereof include a method in which a plastic material and carbon dioxide are supplied into the injection molding machine through a raw material charging hopper provided for supplying the plastic material as a raw material; and a method in which carbon dioxide is supplied separately from the plastic material as a raw material through a nozzle provided in the screw cylinder of the injection molding machine. Among these methods preferred is the method in which carbon dioxide is supplied through a nozzle provided in the screw cylinder, since the method does not require establishing a high pressure in the hopper which has a large volume, the method requires no large-scale equipment, and the machine can be run in a simple manner.

In the case where carbon dioxide is supplied through a nozzle provided in the screw cylinder, the nozzle that supplies carbon dioxide is arranged midway through the passage for the molten plastic material from the raw material charging hopper to the injection nozzle. However, it is preferable that the nozzle through which carbon dioxide is supplied be arranged midway through the passage between a region for plasticizing the plastic material in the screw cylinder and the injection nozzle, since if carbon dioxide is supplied before the pellets of the plastic material are molten, the gasified carbon dioxide backflows to the hopper side without being sealed inside the molten plastic material, thus failing to perform pressurization.

In the present invention, the molten plastic material having carbon dioxide dissolved therein is made free of foreign matter in the molten plastic material with a filter arranged midway through the passage for the molten plastic material in the injection molding machine before the molten plastic material can be injected into the molding die. Arranging the filter in the bore of the injection nozzle located at the tip of the injection molding machine is preferable in consideration of circumventing a complex design of the passage for the molten plastic material and of rendering the arrangement simple. This arrangement enables removal of foreign matter originally present in the plastic material or the foreign matter generated inside the injection molding machine (for example, thermally deteriorated plastic materials).

The filter that can be used is preferably a filter having a filtration precision of 50 μm or less. In particular, in the case where optical components such as photographic lenses and finders of cameras that require high precision are to be produced, it is preferable that filters having a filtration precision of 20 μm or less be used.

The material of the filter is not particularly limited so far as it has sufficient heat resistance, pressure resistance, or mechanical strength at about 300° C., namely the temperature of the molten plastic material passing through the filter. For example, the material of the filter is preferably stainless steel. Examples of the filter include nonwoven fabrics of stainless steel fiber, stainless steel meshes, and sintered products of these, as well as sintered products sintering stainless steel powder. Sintered filters are preferable in view of maintenance of a high filtration precision and exhibition of a high mechanical strength for a prolonged period of time.

Furthermore, in the inventive method, the molten plastic material having carbon dioxide dissolved therein and having passed through the filter is injected into the cavity formed in the molding die preliminarily retained in a state pressurized with a pressurization gas. This prevents gasification/foaming of carbon dioxide dissolved in the molten plastic material, thereby enabling prevention of the occurrence of clouding or porosity (cavities) in the optical components. The pressurization of the molding die with a pressurization gas is retained so as to prevent foaming even after injection of the molten plastic material so that after the optical component in the molding die has been cooled and solidified, the applied pressure is released before the optical component made of plastic can be taken out of the molding die. By retaining the pressurization also after the injection until the optical component formed in the molding die is cooled and solidified, the decrease in solubility of carbon dioxide due to a decrease in pressure, which will result in release of carbon dioxide as a gas to form foams, can be prevented.

The pressurization gas for pressurizing the inside of the molding die is not particularly limited so far as the gas is inactive to the molten plastic material and has no adverse influence on the properties and the like of the obtained optical component. For example, carbon dioxide, nitrogen, hydrocarbons such as methane and ethane, and flons (chloro-fluorocarbon) may be used. In particular, carbon dioxide is preferable since carbon dioxide has no danger of inflammation, is inexpensive and harmless, and has a low critical pressure so that it is easy to handle.

The higher the pressure of the pressurization gas in the molding die, the more advantageous in view of prevention of foaming. However, if the pressure is too high, it makes a resistance to injection. Accordingly, the pressure is selected appropriately so as to make a good balance between the prevention of foaming with the resistance to injection.

Next, an injection molding machine used to implement the inventive method is described below in detail with reference to a preferred embodiment shown in the accompanying drawings.

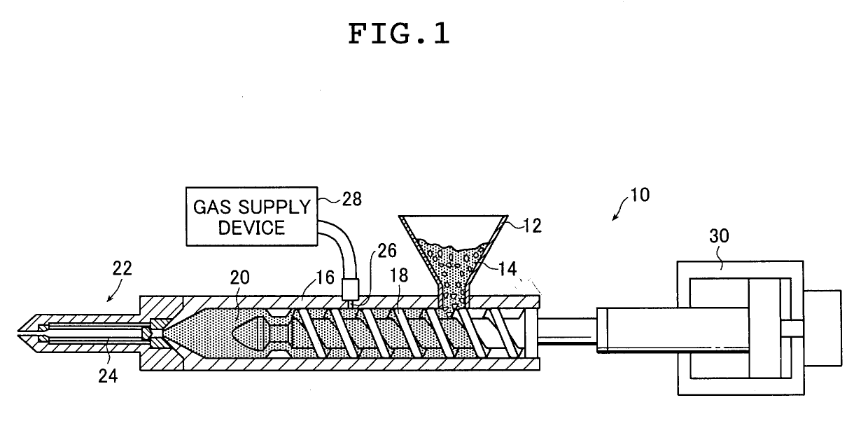

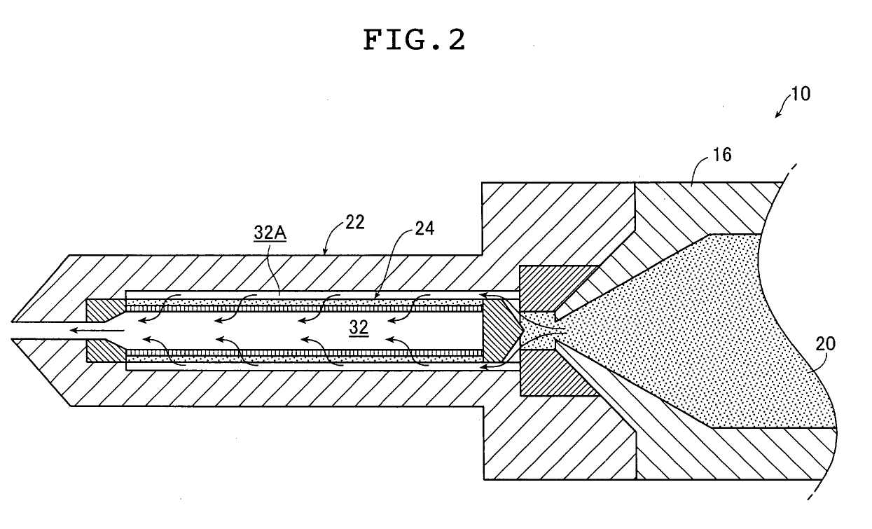

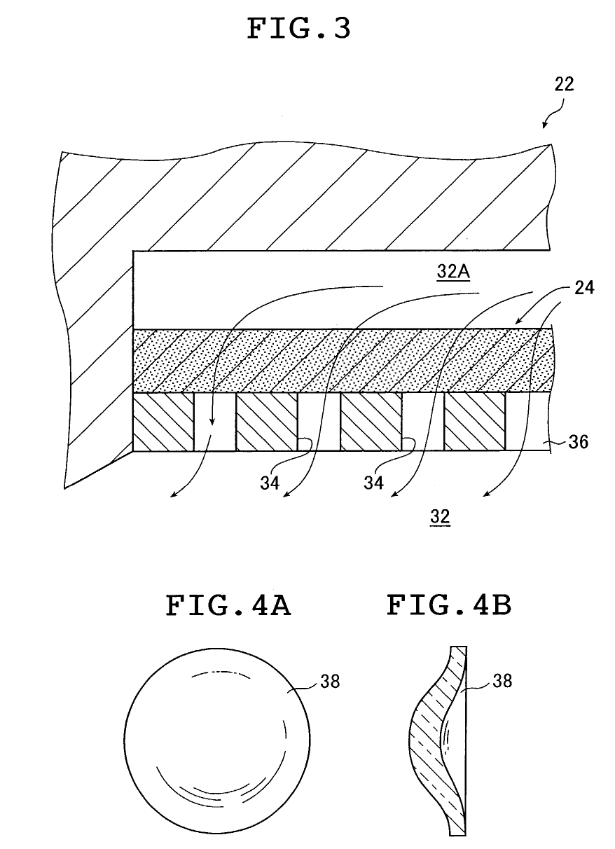

FIG. 1 is a sectional view schematically showing an embodiment of the injection molding machine which is used to implement the inventive method. FIG. 2 is a partially enlarged sectional view showing an essential part including an injection nozzle of the injection molding machine shown in FIG. 1. FIG. 3 is an enlarged sectional view of a filter provided in the injection nozzle shown in FIG. 2. FIG. 4A is a plan view of an exemplary aspherical lens produced by the method of producing a plastic optical component according to the present invention. FIG. 4B is a sectional view of the aspherical lens shown in FIG. 4A.

An injection molding machine 10 shown in FIG. 1 adopts an in-line system in which plasticizing function of a raw material is integrated with injection function thereof.

The injection molding machine 10 adopting the in-line system comprises a hopper 12 which supplies a plastic material 14 as a raw material, a heating screw cylinder (hereinafter simply referred to as a “cylinder”) 16 which melts the plastic material 14 supplied from the hopper 12, a screw 18 which is inserted into the cylinder 16 and is rotated to move the plastic material 14 supplied from the hopper 12 forward in the cylinder 16 while melting the plastic material 14, and measures the amount of a molten plastic material 20, an injection nozzle 22 which is attached to the tip of the cylinder 16 and injects the molten plastic material 20 in the cylinder 16 into a die (not shown) for producing a plastic optical component (not shown), a filter 24 which is provided in the injection nozzle 22 and is used to remove foreign matter in the molten plastic material 20, a gas supply port (hereinafter referred to as a “supply nozzle”) 26 which is provided in the central portion of the cylinder 16 to supply carbon dioxide to be dissolved in the molten plastic material 20 included in the cylinder 16, a gas supply device 28 which supplies carbon dioxide to the supply nozzle 26, and a hydraulic cylinder 30 which moves forward the screw 18 at rest so that the molten plastic material 20 in the cylinder 16 can be injected through the injection nozzle 22.

In the injection molding machine 10 of the in-line system, when the plastic material 14 used as the raw material is supplied to the hopper 12, the supplied plastic material 14 falls into the cylinder 16 under its own weight.

The plastic material 14 having fallen into the cylinder 16 is moved forward in the cylinder 16 while being molten by the rotation of the screw 18, which is pushed backward under the pressure of the molten plastic material 20 moved to the tip end of the screw 18. Then, a predetermined amount of carbon dioxide supplied from the supply nozzle 26 is dissolved in the molten plastic material 20 moved forward in the cylinder 16.

The amount of the molten plastic material 20 is measured based on how long the screw 18 is pushed backward, and when the screw 18 is retracted to reach a predetermined position, the screw 18 stops its rotation. Here, carbon dioxide is dissolved in the measured molten plastic material 20, which is then moved forward in the cylinder 16 together with the screw 18 by means of the hydraulic cylinder 30 behind the screw 18. The molten plastic material 20 having a determined amount of carbon dioxide dissolved therein is then injected through the injection nozzle 22 into a die (not shown) pressurized for molding a plastic optical component (not shown).

As shown in FIGS. 1 and 2, the injection nozzle 22 is fixed on the tip end of the injection molding machine 10. The molten plastic material 20 having carbon dioxide dissolved therein is injected into a pressurized die (not shown) through the injection nozzle 22 after having been moved forward in the cylinder 16.

In the axially central portion of the injection nozzle 22, is formed a cylindrical bore 32 whose inside diameter is larger than the inside diameters of both the ends of the injection nozzle 22. A tubular filter 24 whose inside diameter is smaller than that of the bore 32 is concentrically secured in the bore 32.

This layout allows the molten plastic material 20 to be flown into a space 32A formed in the injection nozzle 22 between the inner surface of the bore 32 and the outer surface of the filter 24 and then from the space 32A into the inner surface side of the filter 24. Foreign matter of smaller sizes can be removed by the filtration, because the molten plastic material 20 having flown into the injection nozzle 22 has carbon dioxide dissolved therein and hence is low in viscosity, the pressure loss due to the filter 24 is small, and the resistance to pressure the filter 24 requires is also decreased.

As shown in FIG. 3, a tubular reinforcing plate 36 having a plurality of holes 34 formed therein is attached to the inner wall of the filter 24, whereby the mechanical strength of the filter 24 is maintained. The molten plastic material 20 having flown into the inner surface side of the filter 24 thus passes through the holes 34 of the reinforcing plate 36 to be guided to the tip end of the injection nozzle 22.

The filter 24 is formed from a nonwoven fabric of sintered metal fiber. The molten plastic material 20 (see FIG. 2) whose viscosity was lowered by dissolving carbon dioxide therein can be readily passed through the filter 24 which has a filtration precision of 50 μm or less and which has particularly a filtration precision of 20 μm or less in optical components requiring high precision, such as the photographic lenses or finders of cameras.

Therefore, even if the molten plastic material 20 rendered low viscosity shown in FIGS. 1 and 2 which has flown from the interior of the cylinder 16 into the injection nozzle 22 contains foreign matter, the molten plastic material 20 passes through the filter 24 smoothly, whereby the foreign matter in the molten plastic material 20 is removed without fail.

The molten plastic material 20 which has carbon dioxide dissolved therein and from which foreign matter has been removed is thereafter injected through the injection nozzle 22 into a pressurized molding die, where the molten plastic material 20 is cooled and solidified.

After having been flown through the injection nozzle 22 into a pressurized molding die, the molten plastic material 20 in which carbon dioxide is dissolved is molded into a plastic optical component. The plastic optical component has no foreign matter which may impair the function of the plastic optical component, nor does carbon dioxide dissolved in the molten plastic material 20 cause gasification, foaming or clouding. It is thus possible to attain the precision necessary for the optical component and also the cost reduction through the decrease of the fraction defective.

In the present invention, the molten plastic material 20 may be filtered through the filter 24 from the outer surface side to the inner surface side or from the inner surface side to the outer surface side to the contrary. However, the illustrated case where the molten plastic material 20 is filtered through the filter 24 formed into a substantially tubular shape from its outer surface side to its inner surface side is more preferable than the case where the molten plastic material 20 is filtered through the filter 24 from its inner surface side to its outer surface side because of the strength of the filter 24 ensured and ease of regeneration and cleaning.

The filter 24 may be formed of a single layer but is preferably a laminate composed of plural layers different in filtration precision. For example, plural layers may be laminated so that the filtration precision is more coarse on the entrance side of the filter 24 through which the molten plastic material 20 passes and finer on the exit side thereof. This lamination enables more effective removal of foreign matter present in the molten plastic material 20.

The filter 24 is provided inside the injection nozzle 22 located in the tip end of the injection molding machine 10 in the embodiment under consideration. However, the filter 24 is not necessarily provided inside the injection nozzle 22, because the filter 24 can be provided in any portion where the molten plastic material 20 obtained by plasticizing the plastic material 14 is not injected yet into a die for use in molding a plastic optical component.

The injection molding machine adopting the in-line system has been described in this embodiment, but the inventive method may be applied to an injection molding machine which adopts a pre-plunger system in which the plasticizing function is separated from the injection function. Further, the inventive method may be applied, based on a general injection molding method adopting the in-line system or the like, to an injection compression molding method in which an insert die is moved inside the cavity during the pressure retaining process in injection molding, or a heat cycle molding method in which the temperature of a die is changed to control the cooling and solidification of a molded product.

As described in detail in the foregoing, according to the inventive method, the viscosity of the molten plastic material can be decreased, the pressure loss at the time of filtration can be made low even when a filter having a high filtration precision is arranged in the injection molding machine, thereby causing no breakage of the filter, thus enabling downsizing of the filter. Furthermore, since, according to the inventive method, foreign matter can be sufficiently removed with a filter having a general-purpose pressure resistance property, the method is effective for decreasing the failure of plastic optical components due to contamination by foreign matter, increasing their yield, and decreasing their production cost.

### EXAMPLES

Hereinafter, the present invention will be described in more detail by way of examples and comparative examples. However, the present invention should not be considered to be limited to the following examples.

### Example 1

As a raw material, acrylic resin pellets (plastic material 14) preliminarily dried in a hot air dryer kept at 90° C. for 4 hours were provided. As an injection molding machine, the injection molding machine of an in-line system as shown in FIG. 1 was used which has a gas supply port (supply nozzle) 26 located substantially in the center of a cylinder 16, a filter 24 made of a stainless steel nonwoven fabric having a filtration precision of 20 μm attached to a bore of an injection nozzle 22 at the tip end of the injection molding machine, and a purge switching valve (not shown) provided on the side of a screw 18 between the cylinder 16 and the injection nozzle 22.

The acrylic resin pellets 14 were supplied from a raw material hopper 12 into the cylinder 16 and melt and kneaded by the screw 18 at 270° C. On this occasion, the purge switching valve was operated to open a purge opening (not shown) and a molten plastic material 20 was purged through the purge opening until no foreign matter could be recognized in the molten plastic material 20.

Then, after foreign matter could be no longer recognized in the molten plastic material 20 being purged, a gas supply device 28 such as a carbon dioxide bomb was used to supply carbon dioxide through the gas supply port (supply nozzle) 26 in the cylinder 16 under a pressure of 7 MPa. After the inclusion of carbon dioxide foams in the molten plastic material 20 and the decrease in the viscosity of the molten plastic material 20 were confirmed, the purge switching valve was switched to the side of the injection nozzle 22 which allows the passage of the molten plastic material 20 therethrough and the molten plastic material 20 was filtered through the filter 24. The injection speed was controlled so that the maximum speed at which the molten plastic material 20 passes through the filter 24 during injection reaches 0.07 ml/cm² sec and the molten plastic material 20 was injected through the injection nozzle 22 into a molding die (not shown) pressurized at 5 MPa with carbon dioxide. On this occasion, the amount of carbon oxide dissolved in the molten plastic material 20 was about 2 mass %.

After the injection of the molten plastic material 20, the inside of the molding die was continuously pressurized with carbon dioxide while a molded product (aspherical lens 38 shown in FIGS. 4A and 4B) obtained in the molding die as a plastic optical component was allowed to be cooled and solidified. After the cooling, the molding die was opened and the molded product was taken out therefrom.

The molded product obtained was visually checked and those samples on which foreign matter exceeding a boundary sample was detected were evaluated as rejected. As a result, the fraction defective was 5%.

### Comparative Example 1

Injection molding was performed in the same manner as in Example 1 except that no carbon dioxide was supplied into the cylinder through the gas supply port and that no pressurization with carbon dioxide was performed in the molding die before injection. Although a molded product was obtained, the injection pressure was high and check of the filter indicated that the filter material was deformed and broken.

### Comparative Example 2

Injection molding was performed in the same manner as in Example 1 except that no pressurization with carbon dioxide was performed in the molding die. As a result, the molded product obtained showed clouding due to foaming of carbon dioxide in the molding die and could not be used as an optical component.

From the above, it has been demonstrated that the present invention shows low filtration pressure loss and causes no breakage of a filter even when a high filtration precision filter is provided in an injection molding machine, and is capable of significantly reducing the fraction defective of plastic optical components due to contamination by foreign matter or clouding resulting from foaming of carbon dioxide.

What is claimed is:

1. A method of producing a plastic optical component from a plastic material using an injection molding machine, comprising:
removing foreign matter from a molten plastic material having dissolved therein 0.1 mass % or more of carbon dioxide through a filter arranged midway through a passage for the molten plastic material provided in the injection molding machine; and
injecting the molten plastic material into a molding die of the injection molding machine, the molding die being preliminarily pressurized with a pressurization gas to prevent foaming of the molten plastic material.

2. The method according to claim 1, wherein the carbon dioxide is dissolved in the molten plastic material in a dissolution amount of 0.5 to 5 mass %.

3. The method according to claim 1, wherein the carbon dioxide is dissolved in the molten plastic material by a method comprising supplying the carbon dioxide together with the plastic material through a raw material charging hopper provided for supplying the plastic material into the injection molding machine.

4. The method according to claim 1, wherein the carbon dioxide is dissolved in the molten plastic material by a method comprising supplying the carbon dioxide through a nozzle provided in a screw cylinder of the injection molding machine separately from the plastic material.

5. The method according to claim 4, wherein the nozzle for supplying the carbon dioxide provided in the screw cylinder is arranged midway through a passage for the molten plastic material from a raw material charging hopper of the injection molding machine to an injection nozzle of the injection molding machine.

6. The method according to claim 5, wherein the nozzle for supplying the carbon dioxide is arranged midway through the passage from a plasticizing region of the plastic material in the screw cylinder to the injection nozzle.

7. The method according to claim 1, wherein the filter is arranged in a bore of an injection nozzle located at a tip of the injection molding machine.

8. The method according to claim 1, wherein the filter has a filtration precision of 50 μm or less.

9. The method according to claim 8, wherein the filter has a filtration precision of 20 μm or less.

10. The method according to claim 1, wherein the filter is of a material that has sufficient heat resistance, pressure resistance or mechanical strength at a temperature of the molten plastic material.

11. The method according to claim 10, wherein the material of the filter is stainless steel.

12. The method according to claim 10, wherein the filter comprises a member selected from the group consisting of nonwoven fabrics of stainless steel fiber, stainless steel meshes, sintered products of the nonwoven fabrics of the stainless steel fiber and the stainless steel meshes, and sintered products sintering stainless steel powder.

13. The method according to claim 1, wherein pressurization in the molding die with the pressurization gas is retained to prevent foaming after the molten plastic material is injected, and wherein the pressurization is released after the molten plastic material in the molding die is cooled and solidified, and a plastic optical component is taken out of the molding die.

14. The method according to claim 1, wherein the pressurization gas for pressurizing an inside of the molding die is one member selected from the group consisting of carbon dioxide, nitrogen, methane, ethane, flon, and mixtures thereof.

15. The method according to claim 14, wherein the pressurization gas is carbon dioxide.

16. The method according to claim 1, wherein the plastic material is a member selected from the group consisting of methacrylic resins, acrylic resins, polycarbonate resins, polystyrene resins, acrylonitrile/styrene resins, tricyclodecane-ring-containing resins, cycloolefin polymers, polymethylpentenes, styrene/butadiene copolymers, and fluorene-group-containing polyesters.
